(19) United States
(12) Patent Application Publication
(10) Pub. No.: US 2024/0331460 A1
(43) Pub. Date: Oct. 3, 2024

(54) NOISE DIAGNOSTICS SYSTEM

(71) Applicant: GM GLOBAL TECHNOLOGY OPERATIONS LLC, Detroit, MI (US)

(72) Inventors: Michael Andrew Gutierrez, Dearborn Heights, MI (US); Tony C. Norris, Highland, MI (US)

(73) Assignee: GM GLOBAL TECHNOLOGY OPERATIONS LLC, Detroit, MI (US)

(21) Appl. No.: 18/194,818

(22) Filed: Apr. 3, 2023

(51) Int. Cl. G07C 5/08; G01S 15/89

(52) U.S. Cl. CPC G07C 5/0808; G01S 15/89

(57) ABSTRACT

Methods and systems are provided that include: a sensor assembly configured to at least facilitate: detecting when a vehicle approaches the sensor assembly; and obtaining sound data, via one or more microphones of the sensor assembly, when the vehicle approaches the sensor assembly; and a processor that is coupled to the sensor assembly and that is configured to at least facilitate generating a mapping of sound across a surface of the vehicle, using the sound data.

### TECHNICAL FIELD

The technical field generally relates to vehicles and, more specifically, to systems and methods for performing diagnostics for vehicles via analysis of noise information for the vehicle.

### BACKGROUND

Vehicles today typically require diagnostics, for example for various systems thereof. However, existing techniques may not always be optimal for performing vehicle diagnostics, and/or may require significant time and resources of human technicians.

Accordingly, it is desirable to provide improved methods and systems for performing diagnostics for vehicles. Furthermore, other desirable features and characteristics of the present invention will become apparent from the subsequent detailed description of the invention and the appended claims, taken in conjunction with the accompanying drawings and this background of the invention.

### SUMMARY

In an exemplary embodiment, a method is provided that includes: detecting when a vehicle approaches a sensor assembly of a diagnostics system; obtaining sound data, via one or more microphones, when the vehicle approaches the sensor assembly; and generating, via a processor, a mapping of sound across a surface of the vehicle, using the sound data.

Also in an exemplary embodiment, the method further includes comparing, via the processor, the mapping with one or more prior known signatures from the vehicle, from one or more other vehicles with common features as the vehicle, or both.

Also in an exemplary embodiment, the method further includes providing diagnostics for the vehicle based on the comparing of the mapping with the one or more prior known signatures.

Also in an exemplary embodiment, the method further includes obtaining vision data, via one or more cameras, when the vehicle approaches the sensor assembly; wherein the mapping, comparing, and providing of diagnostics are performed using the vision data in addition to the sound data.

Also in an exemplary embodiment, the generating of the mapping includes generating, via the processor: a first mapping using a noise level from the sound data over the surface of the vehicle; and a second mapping using frequency domain from the sound data over the surface of the vehicle.

Also in an exemplary embodiment, the method further includes: comparing, via the processor, the first mapping and the second mapping with prior known signatures from the vehicle, from one or more other vehicles with common features as the vehicle, or both; and providing diagnostics for the vehicle based on the comparing of the first mapping and the second mapping with the prior known signatures.

Also in an exemplary embodiment, the comparing of the first mapping and the second mapping includes comparing the first mapping and the second mapping with the prior known signatures that are associated with one or more conditions of one or more systems of the vehicle.

Also in an exemplary embodiment, the method further includes providing, via instructions from the processor, a notification for a technician pertaining to the one or more conditions.

Also in an exemplary embodiment, the method further includes updating, via the processor, the first mapping and the second mapping based on findings of the technician.

In another exemplary embodiment, a diagnostics system is provided that includes: a sensor assembly configured to at least facilitate: detecting when a vehicle approaches the sensor assembly; and obtaining sound data, via one or more microphones of the sensor assembly, when the vehicle approaches the sensor assembly; and a processor that is coupled to the sensor assembly and that is configured to at least facilitate generating a mapping of sound across a surface of the vehicle, using the sound data.

Also in an exemplary embodiment, the processor is further configured to at least facilitate comparing the mapping with one or more prior known signatures from the vehicle, from one or more other vehicles with common features as the vehicle, or both.

Also in an exemplary embodiment, the processor is further configured to at least facilitate providing diagnostics for the vehicle based on the comparing of the mapping with the one or more prior known signatures.

Also in an exemplary embodiment, the sensor assembly is further configured to at least facilitate obtaining vision data, via one or more cameras, when the vehicle approaches the sensor assembly; and the processor is further configured to at least facilitate performing the mapping, comparing, and providing of diagnostics using the vision data in addition to the sound data.

Also in an exemplary embodiment, the processor is further configured to at least facilitate generating: a first mapping using a noise level from the sound data over the surface of the vehicle; and a second mapping using frequency domain from the sound data over the surface of the vehicle.

Also in an exemplary embodiment, the processor is further configured to at least facilitate: comparing the first mapping and the second mapping with prior known signatures from the vehicle, from one or more other vehicles with common features as the vehicle, or both; and providing diagnostics for the vehicle based on the comparing of the first mapping and the second mapping with the prior known signatures.

Also in an exemplary embodiment, the processor is further configured to at least facilitate comparing the first mapping and the second mapping with the prior known signatures that are associated with one or more conditions of one or more systems of the vehicle.

Also in an exemplary embodiment, the processor is further configured to at least facilitate providing, via instructions from the processor, a notification for a technician pertaining to the one or more conditions.

Also in an exemplary embodiment, the processor is further configured to at least facilitate updating the first mapping and the second mapping based on findings of the technician.

In another exemplary embodiment, a diagnostics center is provided that includes: a surface configured to allow a vehicle to roll across; a sensor assembly embedded into the surface and configured to at least facilitate: detecting when the vehicle approaches the sensor assembly as the vehicle rolls across the surface; and obtaining sound data, via one or more microphones of the sensor assembly, when the vehicle approaches the sensor assembly as the vehicle rolls across the surface; and a processor that is coupled to the sensor assembly and that is configured to at least facilitate generating a mapping of sound across a surface of the vehicle, using the sound data.

Also in an exemplary embodiment, the processor is further configured to at least facilitate: comparing the mapping with one or more prior known signatures from the vehicle, from one or more other vehicles with common features as the vehicle, or both; and providing diagnostics for the vehicle based on the comparing of the mapping with the one or more prior known signatures.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle and a diagnostics system, and wherein the diagnostics system is configured to perform diagnostics for the vehicle via analysis of noise data from the vehicle, in accordance with exemplary embodiments; and

FIG. 2 is a flowchart of a process for performing diagnostics for a vehicle via analysis of noise data from the vehicle, and that can be implemented in connection with the system of FIG. 1, including the vehicle and the control system thereof, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

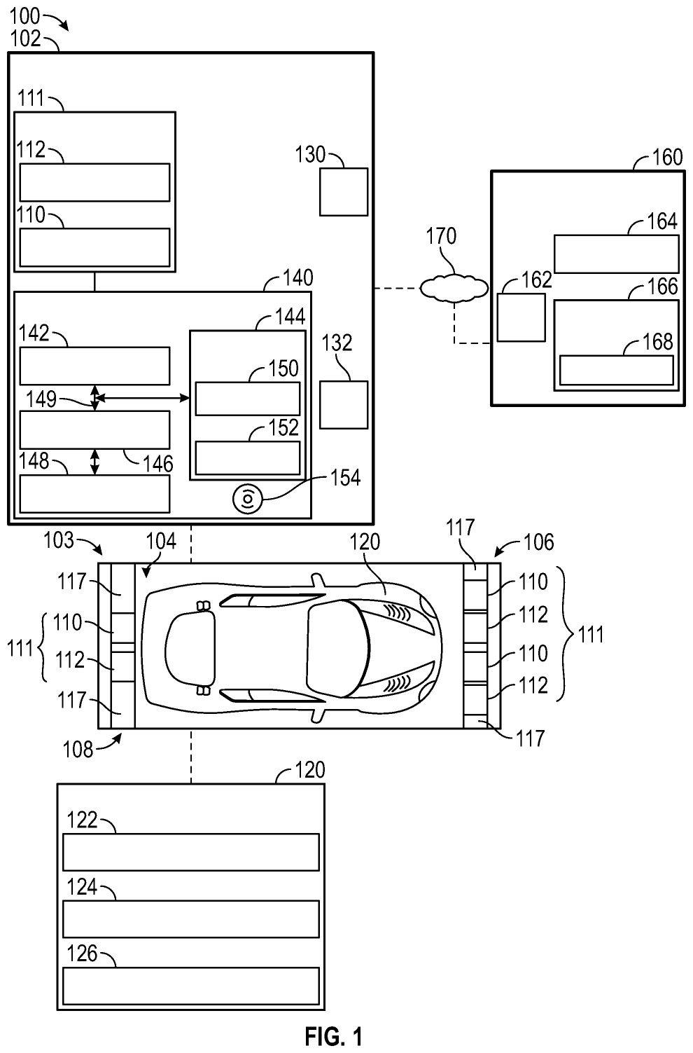

FIG. 1 illustrates a system 100. In various embodiments, and as described below, the system 100 includes a vehicle 120 and a diagnostics system 102 for performing diagnostics for the vehicle 120. Also as described in greater detail below, the diagnostics system 102 performs diagnostics for the vehicle 120 based on analysis of noise data from the vehicle 120. As described in greater detail further below, in various embodiments the diagnostics system 102 includes a sensor array 111, a transceiver 130, a communications port 132, and a controller 140 for providing diagnostics for various vehicles, such as the vehicle 120 of FIG. 1.

While the system 100 depicts a single vehicle 120, it will be appreciated that the system 100 may be configured to perform diagnostics for any number of vehicles, including vehicles of different types. In various the vehicle 120 comprises an automobile. The vehicle 120 may be any one of a number of different types of automobiles, such as, for example, a sedan, a wagon, a truck, or a sport utility vehicle (SUV), and/or various other types of vehicles in certain embodiments. In certain embodiments, the vehicle 120 may also comprise a motorcycle or other vehicle, such as aircraft, spacecraft, watercraft, and so on, and/or one or more other types of mobile platforms (e.g., a robot and/or other mobile platform).

In the depicted embodiment, the vehicle 120 includes various systems 122, sensors 124, and communications devices 126.

In various embodiments, the systems 122 comprise any number of systems 122 that may cause noise, and that may be diagnosed via the diagnostics system 102. In certain embodiments, the systems 122 of the vehicle 120 include, by way of example, one or more engines, motors, drive systems, climate control units, and/or other systems and associated sensors for testing via the diagnostics system 102.

Also in various embodiments, the sensors 124 obtain sensor data pertaining to the various systems 122. In addition, in various embodiments, the sensors 124 provide the sensor data regarding the systems 122 to the diagnostics system 102 for diagnosis.

In various embodiments, the communications devices 126 provide for communication between the vehicle 120 and the diagnostics system 102. In various embodiments, the communications devices 126 facilitate transfer of the sensor data from the sensors 124 to the diagnostics system 102. In certain embodiments, the communication devices comprise a dongle that provides sensor data from the vehicle 120 (e.g., from a communications bus of the vehicle 120) to the diagnostics system 102. In certain other embodiments, one or more other types of communications devices 126 may be utilized.

As depicted in FIG. 1, in various embodiments, the diagnostics system 102 performs diagnostics for the vehicle 120 while the vehicle 120 is disposed within a diagnostics center 103. In various embodiments, the diagnostics center 103 includes a surface 104 on which the vehicle 120 moves (e.g., in which the vehicle 120 rolls).

Also in various embodiments, the diagnostics center 103 further includes a front sensor assembly 106 and a rear sensor assembly 108 in which additional sensor data is obtained with respect to the vehicle 120. In various embodiments, the front sensor assembly 106 and the rear sensor assembly 108 both include respective sensor arrays 111 that include respective microphones 110 and cameras 112 for the monitoring the vehicle 120, and for obtaining sound data and vision data, respectively. Also in various embodiments, the microphones 110 and cameras 112 are covered by and/or embedded within respective coverings 117 for the sensor arrays 111. In addition, in certain embodiments, the sensor arrays 111 along with the respective coverings 117 comprise rumble strips for the diagnostics center. It will be appreciated that while two sensor arrays 111 are depicted in FIG. 1, that in various embodiments any number of sensor arrays 111 may be utilized.

With reference back to the diagnostics system 102, in various embodiments, the diagnostics system 102 provides diagnostics for the vehicle 120, and communicates with the vehicle 120. As noted above, in various embodiments, the sensor array 111 obtains sensor data as to sounds of the vehicle 120, in addition to vision data as to the vehicle 120.

Also in various embodiments, the communications port 132 receives data from the vehicle 120. Specifically, in various embodiments, the communications port 132 receives sensor data from the vehicle 120 from the communications devices 126 thereof (e.g., via a dongle).

In addition, in certain embodiments, the transceiver 130 provides or facilitates communications with a remote server 160 via one or more communications networks 170 (e.g., via one or more wireless communication networks) for further diagnostics of the vehicle 120.

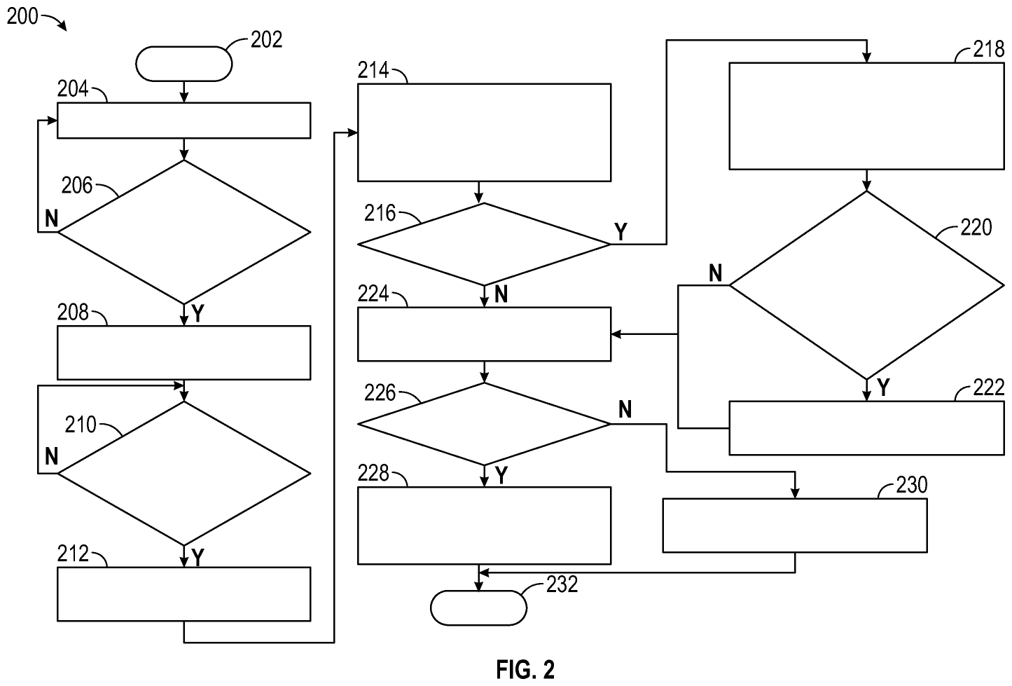

As depicted in FIG. 1, in various embodiments, the controller 140 of the diagnostics system 102 comprises a computer system, and includes a processor 142, a memory 144, an interface 146, a storage device 148, and a computer bus 149. In various embodiments, the controller (or computer system) 140 controls the functions of the diagnostics system 102 (including the performance of diagnostics of the vehicle 120). In various embodiments, the controller 140 provides these and other functions in accordance with the steps of the processes and implementations depicted in FIG. 2 and as described further below in connection therewith.

In various embodiments, the processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 150 contained within the memory 144 and, as such, controls the general operation of the controller 140 and the computer system of the controller 140, generally in executing the processes described herein, such as the processes and implementations depicted in FIG. 2 and as described further below in connection therewith.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 150 along with stored values 168 (e.g., that may include sound data and mappings and other information pertaining thereto).

The bus 149 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the vehicle 120 and/or the sensor arrays 111 of the diagnostics system 102. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 150 that executes one or more embodiments of the processes and implementations of FIG. 2 and as described further below in connection therewith. In another exemplary embodiment, the program product may be directly stored in and/or otherwise accessed by the memory 144 and/or a secondary storage device (e.g., disk 157), such as that referenced below.

The bus 149 can be any suitable physical or logical means of connecting computer systems and components. This includes, but is not limited to, direct hard-wired connections, fiber optics, infrared and wireless bus technologies. During operation, the program 150 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

Also in certain embodiments, as noted above, the system 100 may also include a remote server 160. In various embodiments, the remote server 160 performs diagnostics for the vehicle 120, assists in performing the diagnostics, and/or provides information to the diagnostics system 102 for performing diagnostics for the vehicle 120 and/or for other vehicles. As depicted in FIG. 1, in various embodiments, the remote server 160 includes a transceiver 162, a processor 164, and a memory 166 having stored values 168 therein. In various embodiments, the transceiver 162 communicates with the transceiver 130 of the vehicle 120. Also in various embodiments, the processor 164 provides diagnostics and/or facilitates diagnostics for the vehicle 120 (e.g., similar to the processor 142 of the vehicle 120). In addition, in certain embodiments, the memory 166 stores sound data (including mappings of the sound data) for use by the processors 142 and/or 164 for performing diagnostics for the vehicle 120.

With reference to FIG. 2, a flowchart is provided of a process 200 for performing diagnostics for a vehicle via analysis of noise data from the vehicle, in accordance with exemplary embodiments. In various embodiments, the process 200 may be implemented in connection with the system 100 of FIG. 1, including the vehicle 120 and the diagnostics system 102 thereof, in accordance with exemplary embodiments.

As depicted in FIG. 2, in various embodiments, the process 200 begins at 202. In various embodiments, the process 200 begins when a vehicle (such as the vehicle 120 of FIG. 1) is located within the diagnostics center 103 of FIG. 1. For example, in certain embodiments, the process 200 begins when the vehicle 120 is placed upon the surface 104 of FIG. 1 for diagnostics. In various embodiments, during diagnostics, the vehicle 120 is rolled along the surface 104, from the rear sensor assembly 108 through the front sensor assembly 106.

In various embodiments, sensor data is obtained (step 204). In various embodiments, sensor data is obtained from the sensor arrays 111 of the diagnostics system 102, including from the microphones 110 and cameras 112 thereof. Also in various embodiments, sensor data is also obtained from the sensors of the vehicle 120, for example as provided to the diagnostics system via the communications device 126 of the vehicle 120 via the communications port 132 of the diagnostics system 102.

In various embodiments, a determination is made as to whether a front end of the vehicle 120 has crossed the rear sensor assembly 108 of FIG. 1 (step 206). In various embodiments, this determination is made by a processor, such as the processor 142 of FIG. 1, using the sensor data (e.g., using vision data from the cameras 112 in certain embodiments). In various embodiments, if it is determined that the front end of the vehicle 120 has not crossed the rear sensor assembly 108, then the process returns to step 204, and steps 204-206 repeat until a determination is made during an iteration of step 206 that the front end of the vehicle 120 has crossed the rear sensor assembly 108.

In various embodiments, once it is determined that the front end of the vehicle 120 has crossed the rear sensor assembly 108, diagnostics drive through recording begins (step 208). In various embodiments, recording is performed of sensor data including sound data and vision data from the vehicle 120 via the microphones 110 and cameras 112.

In various embodiments, a determination is made as to whether a rear end of the vehicle 120 has crossed the front sensor assembly 106 of FIG. 1 (step 210). In various embodiments, this determination is made by a processor, such as the processor 142 of FIG. 1, using the sensor data (e.g., using vision data from the cameras 112 in certain embodiments). In various embodiments, if it is determined that the rear end of the vehicle 120 has not crossed the front sensor assembly 106, then the drive through recording of step 208 continues until a determination is made during an iteration of step 210 that the front end of the vehicle 120 has crossed the front sensor assembly 106.

In various embodiments, once it is determined that the rear end of the vehicle 120 has crossed the front sensor assembly 106, diagnostics drive through recording ends (step 212).

In various embodiments, maps are generated based on the captured data (step 214). In various embodiments, a noise level map is generated with respect to noise levels (e.g., in decibels, or dB) over the vehicle surface compared with the expected noise signature of the vehicle 120. In addition, also in various embodiments, another noise level map is generated with respect to a noise frequency domain (e.g., in hertz, or Hz) over the vehicle surface compared with the expected noise signature of the current noise frequencies of the vehicle 120. In various embodiments, the mappings pertain to noise signatures expected for vehicles that may be the same as the vehicle 120 (e.g., an identical vehicle as having the same vehicle identification number, or VIN) and/or another vehicle that may be similar to the vehicle 120, for example of the same or similar make and model, and/or having the same or similar engine type (e.g., cylinder count), climate control units (e.g., via an air conditioning compressor), electric drive unit, and so on. In certain embodiments, the mappings and known signatures are stored in a computer memory, such as the memory 144 and/or memory 166 of FIG. 1. In addition, in certain embodiments, the mappings and comparisons may also be generated and compared using vision data, in addition to the sound data.

In various embodiments, a determination is made as to whether the mappings are incongruent with the vehicle (step 216). In various embodiments, a processor (such as the processor 142 and/or processor 164 of FIG. 1) determines whether the mappings are incongruent (or inconsistent) with the particular vehicle 120 (e.g., via the VIN number) and/or particular type of vehicle (e.g., having the same or a similar engine and/or other components, and so on).

In various embodiments, if it is determined in step 216 that the mappings are congruent, then the process 200 proceeds to step 224, described further below.

Conversely, in various embodiments, if it is determined in step 216 that the mappings are incongruent, then the process 200 proceeds to step 218. In various embodiments, during step 218, a flag is set as to which frequencies or sound levels are congruent on the mappings. In addition, in various embodiments, a notification is provided for providing further diagnostics. In various embodiments, the setting of the flag and the providing of the notification are performed by a processor (such as the processor 142 and/or processor 164 of FIG. 1). In certain embodiments, this is also performed with respect to the vision data, in addition to the sounds data.

Also in various embodiments, a determination is made as to whether the map issue location matches a previously known issue, or whether a related symptom matches a known issue (step 220). In various embodiments, a processor (such as the processor 142 and/or processor 164 of FIG. 1) determines whether the map issue (e.g., the source of the incongruency) matches one or more known and/or previously stored outcomes (e.g., related to known conditions of one or more vehicle systems) for the vehicle and/or a similar vehicle (e.g., with the same VIN number, or the same make and model, or having a similar engine and/or other similar components and/or systems, and so on). In various embodiments, such previously stored outcomes are stored in and retrieved from a computer memory, such as stored values 152 of the memory 144 of FIG. 1 and/or the stored values 168 of the memory 166 of FIG. 1.

In various embodiments, if it is determined in step 220 that the map issue does not match a previously known issue, then the proceeds to step 224, described further below.

Conversely, in various embodiments, if it is instead determined at step 220 that the map issue matches a previously known issue, then information is provided to a technician (step 222). Specifically, in various embodiments, during step 222, a processor (such as the processor 142 or processor 164 of FIG. 1) provides information to a technician (e.g., to a human technician) as to the issue, for example including a description of the problem along with known fixes for the problem associated with the matching map. In various embodiments, the process 200 then proceeds to step 224, described directly below.

During step 224, in various embodiments, a technician performs a physical investigation. Specifically, in various embodiments, a technician (e.g., a human technician) performs a physical investigation of the vehicle 120 of FIG. 1, including the systems 122 thereof, to ascertain any conditions (e.g., problems) that may be present.

In various embodiments, a determination is made as to whether the issue has been located (step 226). In various embodiments, a processor (such as the processor 142 or processor 164 of FIG. 1) determine whether the issue has been located, based on feedback provided by the technician.

In various embodiments, if it is determined in step 226 that the condition has been located, then the issue is mapped (step 228). Specifically, in various embodiments, the issue (e.g., condition) of one or more systems 122 of the vehicle 120 (and/or one or more components and/or areas thereof) are mapped, for example so as to map the issues (e.g., condition) of the one or more systems 122 and/or components and/or areas with the noise level and/or frequency signatures detected from the vehicle 120. In various embodiments, this is performed via a processor (such as the processor 142 or processor 164 of FIG. 1), and the updated mapping is stored in a computer memory (e.g., as updated stored values 152 and/or 168 of the memory 144 and/or memory 166 of FIG. 1) for future use with the present vehicle 120 and/or with other similar vehicles. In various embodiments, the process 200 then ends at step 232.

Conversely, in various embodiments, if it is instead determined in step 226 that the condition has not been located, then the issue is logged as not repeatable (step 230). Specifically, in various embodiments, the mappings are not updated. In various embodiments, the process 200 then ends at step 232.

Accordingly, in various embodiments, methods and systems are provided for providing diagnostics for vehicles. In various embodiments, a sound signature from the vehicle, including noise level and frequency domain, are mapped for the vehicle and compared with stored noise signature data corresponding to various conditions from the vehicle and/or from other similar vehicles. In certain embodiments, vision data is also utilized in combination with the sound data for diagnostics for the vehicle.

It will be appreciated that the systems, vehicles, and methods may vary from those depicted in the Figures and described herein. For example, the system 100 of FIG. 1 and/or various components thereof may differ from that depicted in FIG. 1. It will similarly be appreciated that the steps of the processes of FIG. 2 may differ from those depicted in the Figures, and/or that various steps may occur concurrently and/or in a different order than that depicted in the Figures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
detecting when a vehicle approaches a sensor assembly of a diagnostics system;
obtaining sound data, via one or more microphones, when the vehicle approaches the sensor assembly; and
generating, via a processor, a mapping of sound across a surface of the vehicle, using the sound data.

2. The method of claim 1, further comprising:
comparing, via the processor, the mapping with one or more prior known signatures from the vehicle, from one or more other vehicles with common features as the vehicle, or both.

3. The method of claim 2, further comprising:
providing diagnostics for the vehicle based on the comparing of the mapping with the one or more prior known signatures.

4. The method of claim 3, further comprising:
obtaining vision data, via one or more cameras, when the vehicle approaches the sensor assembly;
wherein the mapping, comparing, and providing of diagnostics are performed using the vision data in addition to the sound data.

5. The method of claim 1, wherein the generating of the mapping comprises generating, via the processor:
a first mapping using a noise level from the sound data over the surface of the vehicle; and
a second mapping using frequency domain from the sound data over the surface of the vehicle.

6. The method of claim 5, further comprising:
comparing, via the processor, the first mapping and the second mapping with prior known signatures from the vehicle, from one or more other vehicles with common features as the vehicle, or both; and
providing diagnostics for the vehicle based on the comparing of the first mapping and the second mapping with the prior known signatures.

7. The method of claim 6, wherein the comparing of the first mapping and the second mapping comprises comparing the first mapping and the second mapping with the prior known signatures that are associated with one or more conditions of one or more systems of the vehicle.

8. The method of claim 7, further comprising:
providing, via instructions from the processor, a notification for a technician pertaining to the one or more conditions.

9. The method of claim 8, further comprising:
updating, via the processor, the first mapping and the second mapping based on findings of the technician.

10. A diagnostics system comprising:
a sensor assembly configured to at least facilitate:
detecting when a vehicle approaches the sensor assembly; and
obtaining sound data, via one or more microphones of the sensor assembly, when the vehicle approaches the sensor assembly; and
a processor that is coupled to the sensor assembly and that is configured to at least facilitate generating a mapping of sound across a surface of the vehicle, using the sound data.

11. The diagnostics system of claim 10, wherein the processor is further configured to at least facilitate:
comparing the mapping with one or more prior known signatures from the vehicle, from one or more other vehicles with common features as the vehicle, or both.

12. The diagnostics system of claim 11, wherein the processor is further configured to at least facilitate providing diagnostics for the vehicle based on the comparing of the mapping with the one or more prior known signatures.

13. The diagnostics system of claim 12, wherein:
the sensor assembly is further configured to at least facilitate obtaining vision data, via one or more cameras, when the vehicle approaches the sensor assembly; and
the processor is further configured to at least facilitate performing the mapping, comparing, and providing of diagnostics using the vision data in addition to the sound data.

14. The diagnostics system of claim 10, wherein the processor is further configured to at least facilitate generating:
a first mapping using a noise level from the sound data over the surface of the vehicle; and
a second mapping using frequency domain from the sound data over the surface of the vehicle.

15. The diagnostics system of claim 14, wherein the processor is further configured to at least facilitate:
comparing the first mapping and the second mapping with prior known signatures from the vehicle, from one or more other vehicles with common features as the vehicle, or both; and
providing diagnostics for the vehicle based on the comparing of the first mapping and the second mapping with the prior known signatures.

16. The diagnostics system of claim 15, wherein the processor is further configured to at least facilitate comparing the first mapping and the second mapping with the prior known signatures that are associated with one or more conditions of one or more systems of the vehicle.

17. The diagnostics system of claim 16, wherein the processor is further configured to at least facilitate providing, via instructions from the processor, a notification for a technician pertaining to the one or more conditions.

18. The diagnostics system of claim 17, wherein the processor is further configured to at least facilitate updating the first mapping and the second mapping based on findings of the technician.

19. A diagnostics center comprising:
a surface configured to allow a vehicle to roll across;
a sensor assembly embedded into the surface and configured to at least facilitate:
detecting when the vehicle approaches the sensor assembly as the vehicle rolls across the surface; and
obtaining sound data, via one or more microphones of the sensor assembly, when the vehicle approaches the sensor assembly as the vehicle rolls across the surface; and
a processor that is coupled to the sensor assembly and that is configured to at least facilitate generating a mapping of sound across a surface of the vehicle, using the sound data.

20. The diagnostics center of claim 19, wherein the processor is further configured to at least facilitate:
comparing the mapping with one or more prior known signatures from the vehicle, from one or more other vehicles with common features as the vehicle, or both; and
providing diagnostics for the vehicle based on the comparing of the mapping with the one or more prior known signatures.
